(19) United States
(12) Patent Application Publication
(10) Pub. No.: US 2013/0117256 A1
(43) Pub. Date: May 9, 2013

(54) SQL ENUMERATOR

(71) Applicants: Bing Gu, Shanghai (CN); Rizal Andre Kertadjaja, Shanghai (CN); Jun Zhao, Shanghai (CN)

(72) Inventors: Bing Gu, Shanghai (CN); Rizal Andre Kertadjaja, Shanghai (CN); Jun Zhao, Shanghai (CN)

(21) Appl. No.: 13/810,896

(22) PCT Filed: Jul. 22, 2010
(86) PCT No.: PCT/US10/42949

§ 371 Date: Jan. 18, 2013

(51) Int. Cl. G06F 17/30

(52) U.S. Cl. CPC G06F 17/30463
USPC 707/718

(57) ABSTRACT

Techniques for collecting database information related to a received request are disclosed herein. In one embodiment a system includes a database, an event detector, and a structured query language (“SQL”) enumerator. The event detector is configured to identify a received request as producing one or more database query language statements and to define an event delimiting processing of the request. The SQL enumerator is configured to record, based on the event, information indicative of how the database processed the statements produced during the event. The SQL enumerator is further configured to provide the recorded information and an indication of a relationship of the information to the request to an issuer of the request.

### BACKGROUND

Systems employ component abstractions to generalize and simplify use of the components. However, abstractions tend to obscure the operations of the components, and hinder efforts to identify performance or functional issues related to the components. In many systems, communication with a database is recognized as a system performance restriction. Database connectivity may be abstracted such that the relationship between an event (e.g., a user action) and database activity is difficult to establish.

### BRIEF DESCRIPTION OF THE DRAWINGS

For a detailed description of exemplary embodiments of the invention, reference will now be made to the accompanying drawings in which:

FIG. 1 shows a block diagram of a system including recording of database activity recording in accordance with various embodiments;

FIG. 2 shows a block diagram of a processor based system including database activity recording in accordance with various embodiments;

FIG. 3 shows a display of aggregated statistics related to structured query language (“SQL”) execution in accordance with various embodiments;

FIG. 4 shows a display of SQL execution information grouped by SQL statement in accordance with various embodiments;

FIG. 5 shows a display of a full SQL statement and an execution plan for the SQL statement in accordance with various embodiments:

FIG. 6 shows a display of a stack trace related to execution of an SQL statement in accordance with various embodiments; and

FIG. 7 shows a flow diagram for a method for recording database activity in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Further, the term “software” includes any executable code capable of running on a processor, regardless of the media used to store the software. Thus, code stored in memory (e.g., non-volatile memory), and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Abstraction serves to simplify use of functionality by hiding the details of operations performed to provide the functionality. Numerous layer of abstraction may be applied in an enterprise-level application. However, by hiding the details of functionality, abstraction tends to limit visibility.

Communication with databases is a significant factor in enterprise-level application performance. When database activity is obscured by an abstraction, such as is provided by an object-relational mapper (“ORM”) (e.g., Hibernate by Red Hat, Inc.), the relationship between an event, such as a user action, and database activity can be difficult to establish.

Embodiments of the present disclosure include a tool (Structured Query Language (“SQL”) Enumerator) that provides visibility into database activities, The SQL enumerator establishes boundaries defining a database related request and response corresponding to an execution thread, and records database activities corresponding to the request. The recorded database activities may be displayed or otherwise provided to expose detailed database operations triggered by receipt of a request in an application that access the database.

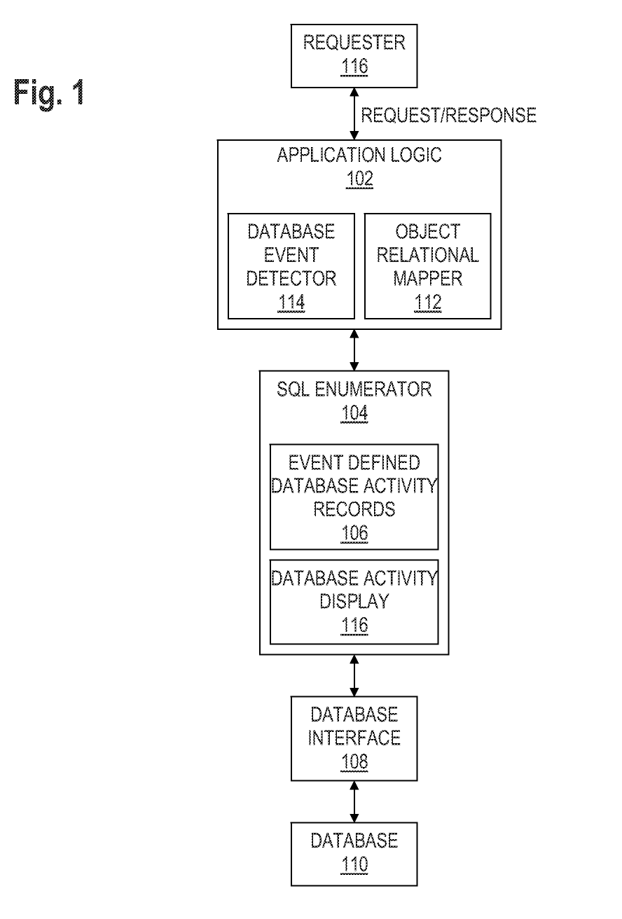

FIG. 1 shows a block diagram of a system including recording of database activities in accordance with various embodiments. The system includes application logic 102, an SQL enumerator 104, a database interface 108, and a database 110. The database 110 may be a relational database, for example, the Oracle Database by Oracle Corporation, DB2 by International Business Machines, SQL Server by Microsoft Corporation, etc.

The application logic 102 is configured to receive requests and to provide responses based on a received request. A request may trigger the application logic 102 to perform an operation. A result of the operation (e.g., data and/or operation status) may be returned to the requester 116 as a response. In some embodiments, a request may be a hypertext transfer protocol (“HTTP”) request and a response may be an HTTP response.

The application logic 102 may include business logic that accesses the database 110, based for example, on a received request. In one embodiment, the application logic 102 is one or more computers executing Project and Portfolio Management by Hewlett Packard. The application logic 102 may include an object relational mapper (“ORM”) 112 (e.g., Hibernate) to facilitate object-oriented logic of the application 102 storing and retrieving data from the relational database 110. The ORM 112 generates structured query language (“SQL”) statements to access the appropriate tables of the relational database 110. Because the ORM 112 obscures database 110 activity related to an object of the application logic 102, it may be difficult to correlate application logic 102 and database 110 activities.

The application logic 102 further includes a database event detector 114. The database event detector 114 identifies requests received from the requester 116 that initiate database 110 activity. The database event detector 114 may delimit an event as beginning with reception of a request and completing with provision of a response to the received request to the requester 116. In some embodiments, the database event detector 114 may include a filter to provide identification of received requests that initiate database 110 activities. In some embodiments, the filter may be provided via Struts by the Apache Software Foundation or an equivalent framework. The filter parses the request to determine whether the request will launch database 110 activities. Determination may be based on parameters of a received request that indicate a database access requirement.

The database interface 108 is connected to the application logic 102 via the SQL enumerator 104. The database interface 108 provides logic for interfacing to a given database 110. In some embodiments of the system 100, for example embodiments in which the application 102 includes Java, the database interface 108 may comprise Java Database Connectivity (“JDBC”). In some embodiments, the database interface 108 may include Open Database Connectivity (“ODBC”) or an equivalent interface. The database interface 108 allows the application 102 to connect to the database 110, and facilitates sending query and other SQL statements to the database 110 and retrieving query results from the database 110.

The SQL enumerator 104 monitors database operations initiated by the application logic 102. Event information is provided to the SQL enumerator 104 by the database event detector 114, allowing the SQL enumerator 104 to reference database activities to a received request causing the activities. The SQL enumerator 104 records each SQL statement (e.g., Statement, Preparedstatmnent, etc.) launched by the application logic 102 during event processing. Embodiments determine a time at which each SQL statement is launched, and/or a time required to process each SQL statement (e.g., by determining a time at which a result of a statement is received from the database 110). Embodiments also retrieve, for each SQL statement executed, a database execution plan and/or a stack trace containing information indicative of steps performed (e.g., methods executed) to launch the statement. In some embodiments, the stack trace is retrieved from a controller (e.g., a Java Virtual Machine) of the application logic 102 that records execution information, and the execution plan is retrieved from the database 110. Information related to database 110 activities corresponding to an event is stored as event defined activity records 106.

The SQL enumerator 104 also includes database activity display logic 116 that provides recorded database activity information 106 as one or more displays on a display device (e.g., a display device associated with the requestor 116).

Embodiments of the SQL enumerator 104 and the application logic 102 can be implemented as dedicated circuitry and/or one or more processors (e.g., general-purpose processors) and/or one or more computers programmed to perform the functions described herein.

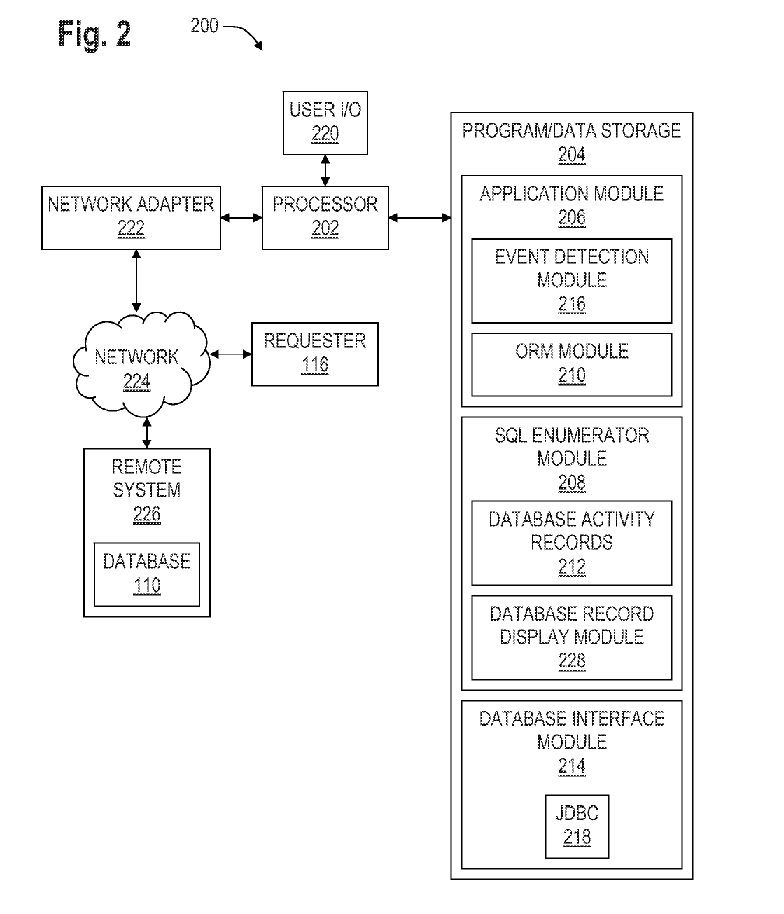

FIG. 2 shows a block diagram of a processor-based system 200 including database activity recording in accordance with various embodiments. The system 200 includes program/data storage 204 and one or more processors 202. Some embodiments of the system 200 also include a network adapter 224 and user I/O devices 220. These elements of the system 200 may be embodied in a computer as is known in the art. Desktop computers, server computers, notebook computers, handheld computers, etc. are exemplary computers that may suitably embody components of the system 200.

The processor 202 is configured to execute instructions read from a computer readable medium, and may, for example, be a general-purpose processor, digital signal processor, microcontroller, etc. Processor architectures generally include execution units (e.g., fixed point, floating point, integer, etc.), storage (e.g., registers, memory, etc.), instruction decoding, peripherals (e.g., interrupt controllers, timers, direct memory access controllers, etc), input/output systems (e.g., serial ports, parallel ports, etc.) and various other components and sub-systems.

The program/data storage 204 is a computer-readable medium that may be coupled to and accessed by the processor 202. The storage 204 may be volatile or non-volatile semiconductor memory (e.g. FLASH memory, static or dynamic random access memory, etc.), magnetic storage (e.g., a hard drive, tape, etc.), optical storage (e.g., compact disc, digital versatile disc, etc.), etc. Embodiments of the program/data storage 204 may be local to or remote from the processor 202. Various programs executable by the processor 202, and data structures manipulatable by the processor 202 may be stored in the storage 204.

User I/O devices 220 coupled to the processor 202 may include various devices employed by a user to interact with the processor 202 based on programming executed thereby. Exemplary user I/O devices 220 include video display devices, such as liquid crystal, cathode ray, plasma, organic light emitting diode, vacuum fluorescent, electroluminescent, electronic paper or other appropriate display panels for providing information to a user. Such devices may be coupled to the processor 202 via a graphics adapter. Keyboards, touchscreens, and pointing devices (e.g., a mouse, trackball, light pen, etc.) are examples of devices includable in the I/O devices 220 for providing user input to the processor 202 and may be coupled to the processor 202 by various wired or wireless communications subsystems, such as Universal Serial Bus or Bluetooth.

A network adapter 222 may coupled to the processor 202 to allow the processor 202 to communicate with a remote system 226 and/or a requestor 116 via the network 224 to, for example, access the database 110 and/or provide services to the requestor 116. The network adapter 222 may allow connection to one or more of a wired or wireless network, for example, in accordance with IEEE 802.11, IEEE 802.3, Ethernet, a cellular network, etc. The network 224 may comprise any available computer networking arrangement, for example, a local area network (“LAN”), a wide area network (“WAN”), a metropolitan area network (“MAN”), the internet, etc. Further, the network 224 may comprise any of a variety of networking technologies, for example, wired, wireless, or optical techniques may be employed. Accordingly, the remote system 226 and the requestor 116 are not restricted to any particular location or proximity to the processor 202.

Referring again to the program/data storage 204, various data and program modules are shown stored therein. The application module 206 may be, for example, a web application that includes instructions for providing services to the requester 116. Some of the services provided to the requester 116 may access data stored in the database 110. The application module 206 may be object oriented (e.g., created using an object-oriented programming language such as Java).

The database 110 may be a relational database (e.g., Oracle Database by Oracle Corporation). The application module 204 may access the database 110 via the ORM module 210, which maps the objects manipulated by the application module 206 to the tables of the relational database 110, and generates SQL statements to perform database 110 accesses. In some embodiments, the ORM module 210 may include Hibernate.

The event detection module 216 identifies requests (e.g., requests received from the requester 116) whose processing initiates database 110 activity. The event detection module 216 defines an event based on receiving a request that initiates database activity, and returning a result of processing the request to the requester 116. In some embodiments, the event detection module 216 may comprise a Java filter designed to identify database related requests based on predetermined database 110 related request parameters.

The database interface module 214 provides programming for interfacing the application module 206 to the database 110. In an embodiment in which the database 110 is a relational database and the application module 206 uses Java programming, the database interface module 214 may comprise Java Database Connectivity (“JDBC”) 218. In some embodiments, the database interface 108 may include Open Database Connectivity (“ODBC”) or another interface. The database interface module 214 allows the application module 206 to connect to the database 110, and facilitates sending query and other SQL statements to the database 110 and retrieving query results from the database 110.

The SQL enumerator module 208 records information related to database 110 activity initiated by a received request. The SQL enumerator module 208 operates between the application module 206 and the database interface module 214 to capture SQL statements generated by the ORM module 210 (or other portion of the application 206), SQL statement execution timing information, database execution plan information, etc. The database activity information captured by the SQL enumerator 208 is stored as database activity records 212, where each record 212 may correspond to a particular event identified by the event detection module 216 and execution thread of the application module 206.

The database record display module 228 provides instructions for displaying the database activity information stored in the records 212 on a display device, such as a display device included in user I/O 220 or a corresponding display device associated with the requester 116.

Database activity recording may be enabled or disabled in accordance with user needs. For example, database activity recording may be enabled to identify inefficient database accesses for optimization by setting a parameter of the application module 206.

In one embodiment of the SQL enumerator module 208, when the application module 206 receives a request from the requester 116 that indicates use of the database 110, the application module 206 requests a database connection. The SQL enumerator module 208 may include a database 110 connection provider that fetches a database connection from a database connection pool or initializes a connection from a driver (e.g., the Oracle Database driver). The SQL enumerator module 208 connection provider initializes an SQL enumerator connection object that wraps the connection and provides the SQL enumerator connection object to the application module 206. The SQL enumerator connection object replicates the connection interface provided by the database interface module 214 (e.g., JDBC 218).

When the application module 204 requests a Statement or Preparedstatement the SQL enumerator connection requests an instance of the requested statement from the underlying connection, and initializes an SQL enumerator object version of the statement that wraps the provided instance of the statement. Requests by the application module 206 to execute SQL on such statements are passed to and recorded by the SQL enumerator module 208, then passed to the underlying Statement or Preparedstatement. Thus, the SQL enumerator module 208 captures and records database activity information with correspondence to a requester 116 provided request while maintaining transparency.

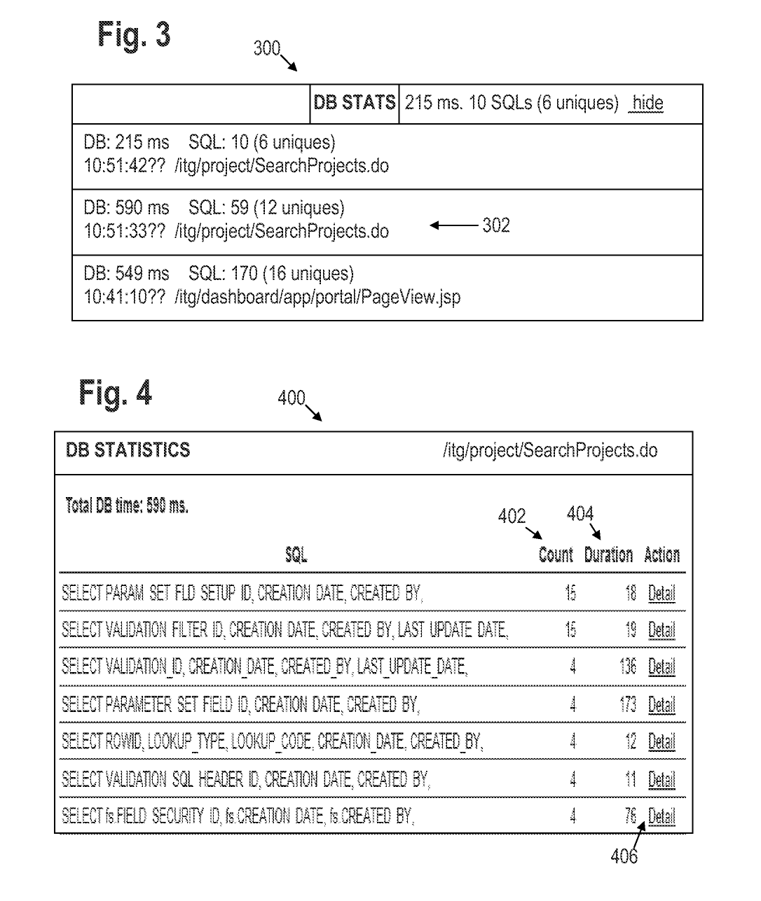

The database activity records 212 as displayed by the database record display module 228 provide database activity information and statistics that may facilitate understanding of a relationship between database activity and system performance. FIG. 3 shows a display 300 of database activity information in accordance with various embodiments. The display 300, generated by the database record display module 228, shows aggregated statistics about execution of SQL statements categorized by request from requester 116 received by the application module 206. For example, the row 302 shows that the request for “SearchProjects.do” executed 59 SQL statements of which 12 were unique. Execution of the 59 statements required 590 milliseconds.

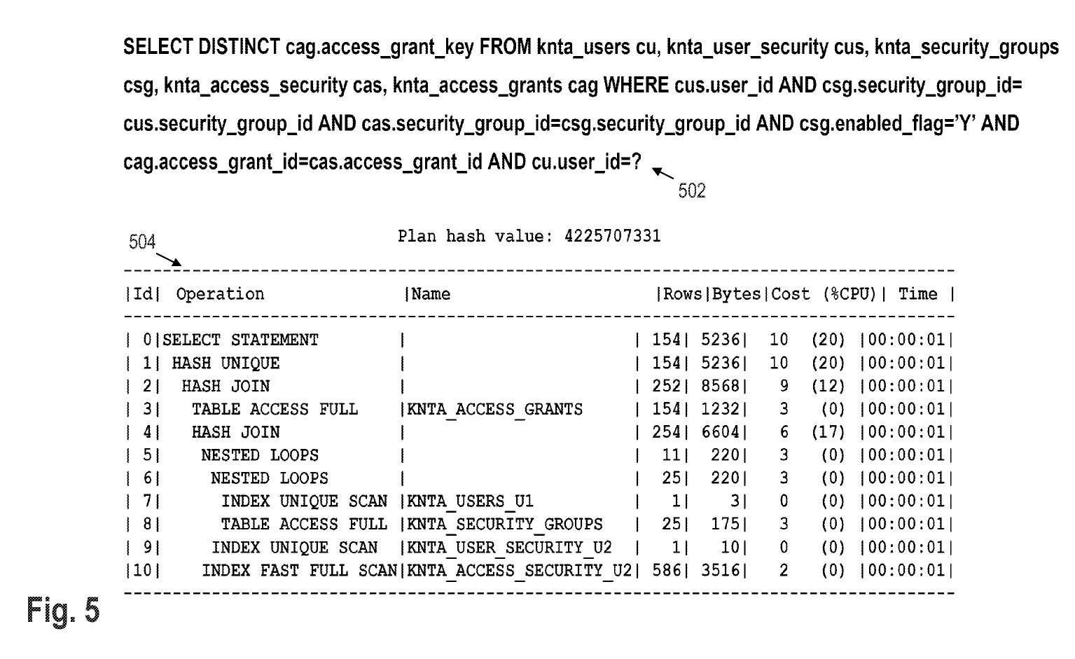

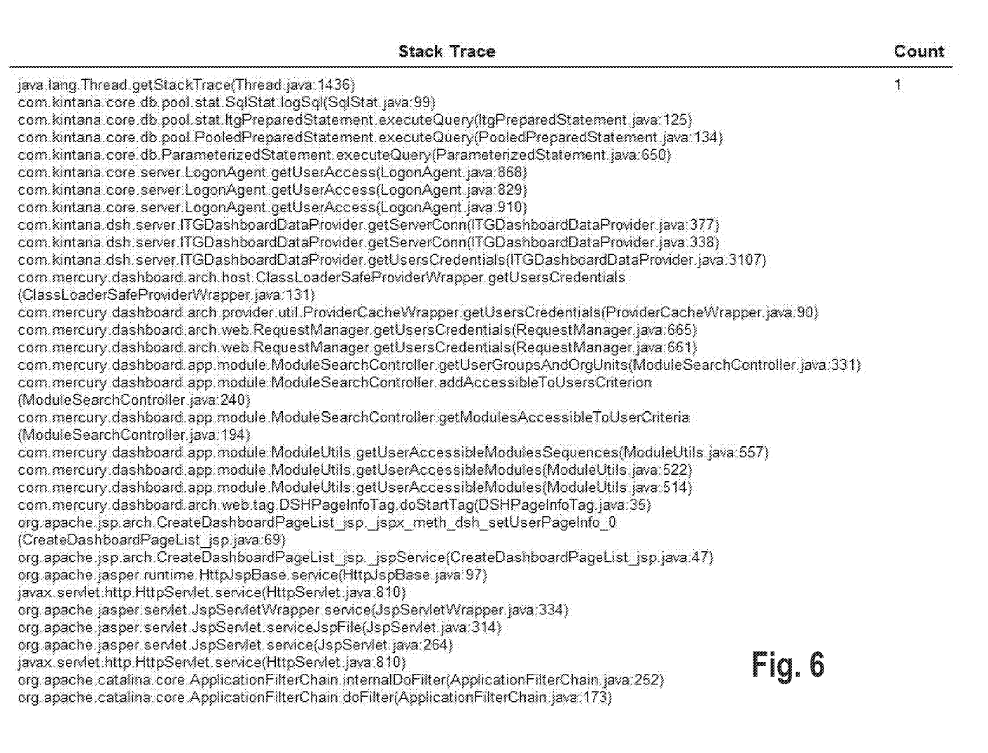

FIG. 4 shows a detailed display 400 of database activity information in accordance with various embodiments. In some embodiments, the information of the display 400 is grouped by SQL statements corresponding to a line of aggregated statistics of the display 300 (i.e., corresponding to a received request). The display 400 may be provided by selecting (e.g., clicking on) a row (e.g., row 302) of the display 300. The display 400 provides a count 402 of the number of times each SQL statement was executed, and a duration 404 of each statement. Additional detail related to an SQL statement may be displayed by selecting the “Detail” link 406 for the statement. In some embodiments, additional information displayed (e.g., via the link 406) includes the full SQL statement 502, and/or a database execution plan 504 for the statement as shown in FIG. 5, and/or a stack trace (e.g., culminating with execution of the SQL statement) as shown in FIG. 6.

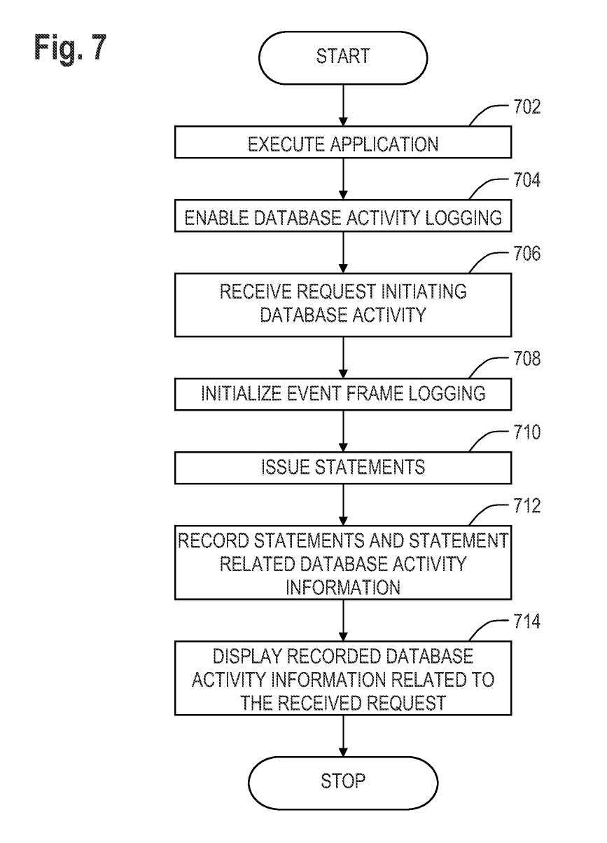

FIG. 7 shows a flow diagram for a method of recording database activity corresponding to received service requests in accordance with various embodiments. Though depicted sequentially as a matter of convenience, at least some of the actions shown can be performed in a different order and/or performed in parallel. Additionally, some embodiments may perform only some of the actions shown. In some embodiments, the operations of FIG. 7, as well as other operations described herein, can be implemented as instructions stored in a computer readable medium (e.g., storage 204) and executed by one or more processors (e.g., processor 202).

In block 702, the application 102 is operating. The application 102 can receive requests from the requester 116, process the requests, access the database 110 as part of the request processing, and provide responses to requests to the requester 116.

In block 704, recording of database 110 activity by the SQL enumerator 104 is enabled. In some embodiments, database 110 activity recording is enabled by setting a logging configuration parameter of the application 102 to a predetermined value.

In block 706, the application 102 receives a request from the requester 116. The database event detector 114 parses the request to determine whether the request will initiate database 110 activity. If the request is determined be one that uses the database 110, then the request defines the start of an event for which database 110 activity will be recorded by the SQL enumerator 104. The event is concluded by providing a response to the request to the requester 116.

In block 708, the SQL enumerator 104 initializes event frame logging. Such initialization may include obtaining a database 110 connection for use during event processing. The connection interjects the SQL enumerator 104 between the application 102 and the database interface 108 to allow the SQL enumerator 104 to collect information related to SQL processing during the event processing. Initialization of event frame logging may also prepare storage for database activity information gathered during event processing.

In block 710, the application 102 issues one or more SQL statements for execution by the database 110. The statements may be, for example, Statements or Preparedstatements associated with the database 110 and/or the database interface 108.

In block 712, the SQL statements are provided to the SQL enumerator 104. The SQL enumerator 104 records the statements as corresponding to the event, gathers timing information relevant to the SQL statements (e.g., time of issue, time response from database 110 received, etc.). The SQL enumerator 104 may also gather and record other information related to execution of each statement, such as a database execution plan, and/or an application 102 stack frame leading to issuance of a statement. All database activity information recorded corresponds to processing of single request (i.e., an event) executed via a single thread. The SQL enumerator may record the SQL statements and other information in a log file or other storage structure along with information identifying the received request that initiated the database activity and information relating the database activity to the received request.

In block 714, the SQL enumerator 104 provides the recorded database activity information 106 for display on a display device. Information displayed may be displayed by correspondence to the initiating request, and may include a total number of query language statements executed, a number of unique query language statements executed, a time required to execute the total number of query language statements, text of each query language statement executed, a number of times each query language statement is executed, an execution time for each query language statement, an execution plan for each query language statement; and a stack trace for each query language statement.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a database;
an event detector configured to:
identify a received request as producing one or more database query language statements; and
define an event delimiting processing of the request; and
a structured query language (“SQL”) enumerator configured to:
record, based on the event, information indicative of how the database processed the statements produced during the event; and
provide the recorded information and an indication of a relationship of the information to the request to an issuer of the request.

2. The system of claim 1, wherein the SQL enumerator is configured to record a time at which each of the statements is launched and an execution time duration for each of the statements.

3. The system of claim 1, wherein the SQL enumerator is configured to record the query language statements executed by the database based on the spawned statements.

4. The system of claim 1, wherein the SQL enumerator is configured to record an execution plan of the database generated for each statement.

5. The system of claim 1, wherein the SQL enumerator is configured to record the number of times each statement is executed between reception of the request and return of a result to a requester.

6. The system of claim 1, wherein the SQL enumerator is configured to record a stack trace for each statement.

7. The system of claim 1, wherein the SQL enumerator is embedded in an application that receives the request.

8. The system of claim 1, wherein the SQL enumerator is configured to provide a display of information generated responsive to the request, the information comprising:
a total number of query language statements executed;
a number of unique query language statements executed;
a time required to execute the total number of query language statements;
text of each query language statement executed;
a number of times each query language statement is executed;
an execution time for each query language statement;
an execution plan for each query language statement; and
a stack trace for each query language statement.

9. A method, comprising:
receiving, by one or more processors, a request;
spawning, by the one or more processors, one or more database query language statements based on the request;
gathering, by the one or more processors, information indicative of how a database processed the statements; and
providing, by the one or more processors, the gathered information and an indication of a relationship of the information to the request to an issuer of the request.

10. The method of claim 9, further comprising recording a time required to service the request, and a time required to execute each query language statement spawned responsive to the request.

11. The method of claim 9, further comprising recording each query language statement spawned responsive to the request, a number of times each statement is executed, and a database execution plan for each statement.

12. The method of claim 9, further comprising displaying the gathered information on a display device, the information comprising:
a total number of query language statements executed;
a number of unique query language statements executed;
a time required to execute the total number of query language statements;
text of each query language statement executed;
a number of times each query language statement is executed;
an execution time for each query language statement;
an execution plan for each query language statement; and
a stack trace for each query language statement.

13. A computer-readable medium encoded with a computer program comprising instructions that when executed cause one or more processors to:
receive a request;
spawn one or more database query language statements based on the request;
gather information indicative of how a database processed the queries; and
provide the gathered information and an indication of a relationship of the information to the request to an issuer of the request.

14. The computer-readable medium of claim 13, wherein the information comprises:
a time required to service the request,
a time required to execute each query language statement spawned responsive to the request;
each query language statement spawned responsive to the request;
a number of times each query language statement is executed; and
an execution plan for each query language statement.

15. The computer-readable medium of claim 13, wherein the receiver of the request is an application program encoded on the medium, and the instructions are embedded in the application program.
